(19) United States
(12) Patent Application Publication
(10) Pub. No.: US 2006/0199410 A1
(43) Pub. Date: Sep. 7, 2006

(54) Method for connecting a terminal to a connector and structure of the terminal

(76) Inventor: Ying Chung Chen, Pan Chiao City (TW)

Correspondence Address: LIN & ASSOCIATES INTELLECTUAL PROPERTY, P.O. BOX 2339, SARATOGA, CA, 95070-0339, US

(21) Appl. No.: 11/274,017

(22) Filed: Nov. 15, 2005

(30) Foreign Application Priority Data
Mar. 2, 2005 (TW) 094106275

(51) Int. Cl. H01R 13/15

(52) U.S. Cl. 439/260

(57) ABSTRACT

A connector includes a passage defined in a rear end thereof and a cover is pivotably connected to the connector. The cover includes plurality of engaging teeth defined in an underside thereof and an axle is located between the engaging teeth. A terminal has a base from which a contact arm and a connection arm extend. The contact arm has a terminal contact end at a distal end thereof and the connection arm has a connection portion projecting from a distal end thereof. A notch is defined in the connection portion. A sharp plate extends from a top side of the connection arm. The terminal extends through the passage of the connector and the axle of the cover is engaged with the notch of the connection arm and the sharp plate is securely in contact with the inside of the passage of the connector.

### BACKGROUND OF THE INVENTION

1. Field of the Invention

The present invention relates generally to a connection of a connector and a terminal, and in particular to a terminal with a connection arm which is connected to the axle of the cover.

2. The Prior Arts

A conventional way of connection of the terminal 30 and the connector 10 is disclosed in FIGS. 1A and 1B, wherein the connector 10 includes a passage defined in a rear end thereof and two engaging recesses are defined in two ends of the connector 10. A cover 12 including two positioning rods is connected to the connector 10 by engaging the positioning rods into the engaging recesses so that the cover 12 is pivotable about the positioning rods. A plurality of engaging teeth 12a are defined in an underside of the cover 12. A space is defined between the passage an the engaging recesses so that a flatcable can be inserted into the space and the cover 12 is then closed to let the line contact ends be in contact with the terminal contact ends.

Referring to FIG. 2, the cover 12 includes an axle 12b which is located between the engaging teeth 12a so that when the terminal 30 extends through the passage, a connection arm 30c of the terminal 30 is engaged with the axle 12b of the cover 12 as shown in FIG. 3A. The cover 12 is then pivoted to its open position as shown in FIG. 3B and a flatcable 40 is inserted into the space as shown in FIG. 3C. As shown in FIG. 3D, the cover 12 is then pivoted downward to its close position and the contact arm 30b of the terminal 30 is deformed slightly and the flatcable 40 is clamped between the cover 12 and the contact arm 30b.

### SUMMARY OF THE INVENTION

A connector includes a passage defined in a rear end thereof and a cover is pivotably connected to the connector. The cover includes plurality of engaging teeth defined in an underside thereof and an axle is located between the engaging teeth. A terminal has a base from which a contact arm and a connection arm extend. The contact arm has a terminal contact end at a distal end thereof and the connection arm has a connection portion projecting from a distal end thereof. A notch is defined in the connection portion. A sharp plate extends from a top side of the connection arm. The terminal extends through the passage of the connector and the axle of the cover is engaged with the notch of the connection arm and the sharp plate is securely in contact with the inside of the passage of the connector.

### BRIEF DESCRIPTION OF THE DRAWINGS

The present invention will be apparent to those skilled in the art by reading the following detailed description of a preferred embodiment thereof, with reference to the attached drawings, in which:

FIG. 1A shows a conventional connector with a cover;

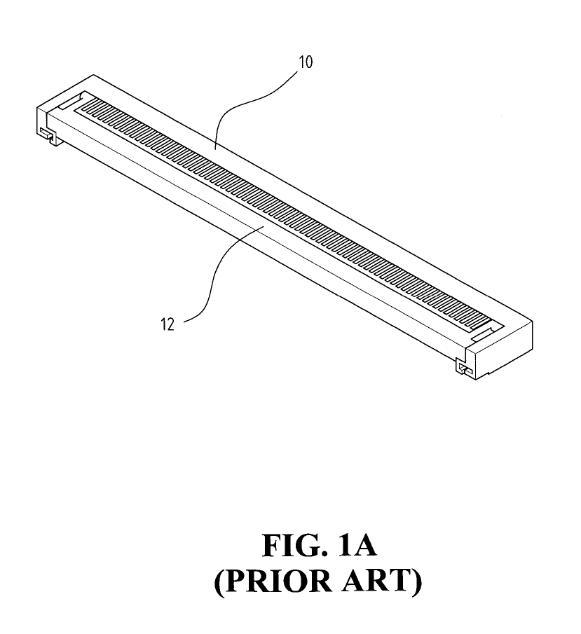

FIG. 1B shows that the cover is pivoted to its open position relative to the connector in FIG. 1A;

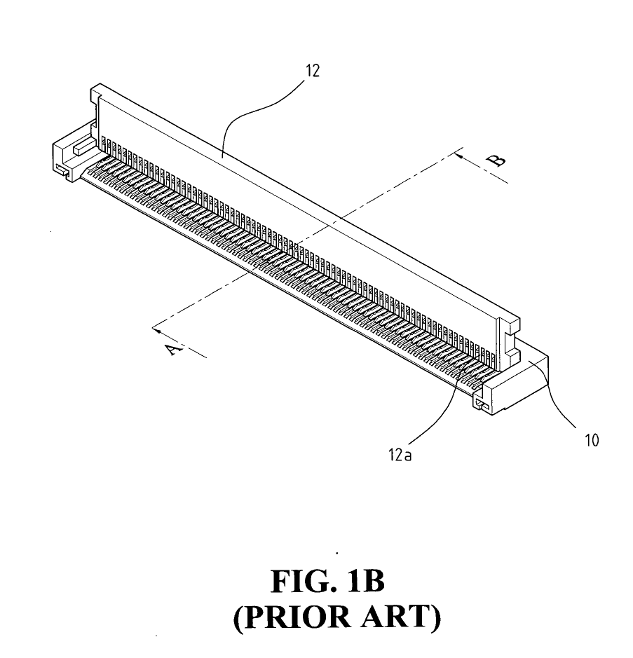

FIG. 2 shows that a conventional terminal is inserted into the connector;

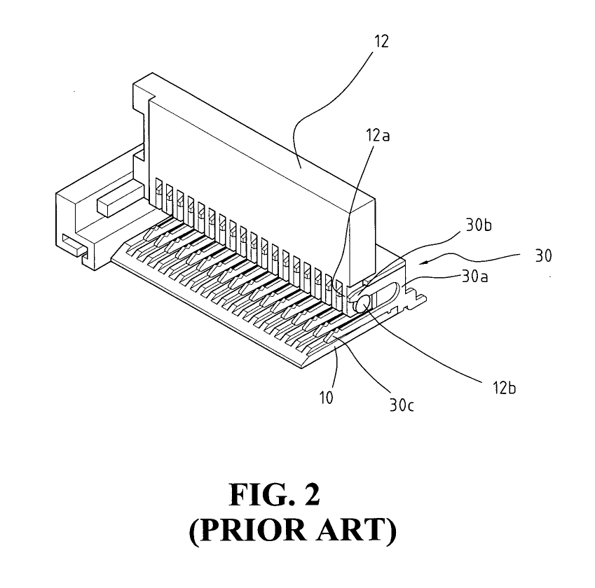

FIG. 3A is a cross sectional view to show that the conventional terminal is inserted into the connector;

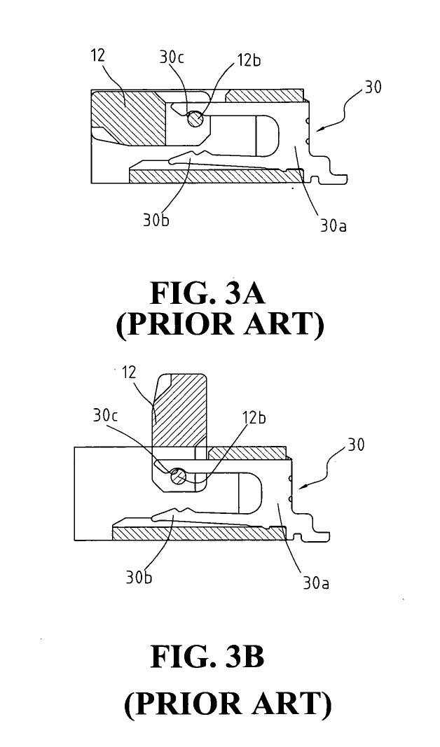

FIG. 3B is a cross sectional view to show that the cover is pivoted and the axle is slightly disengaged from the conventional terminal;

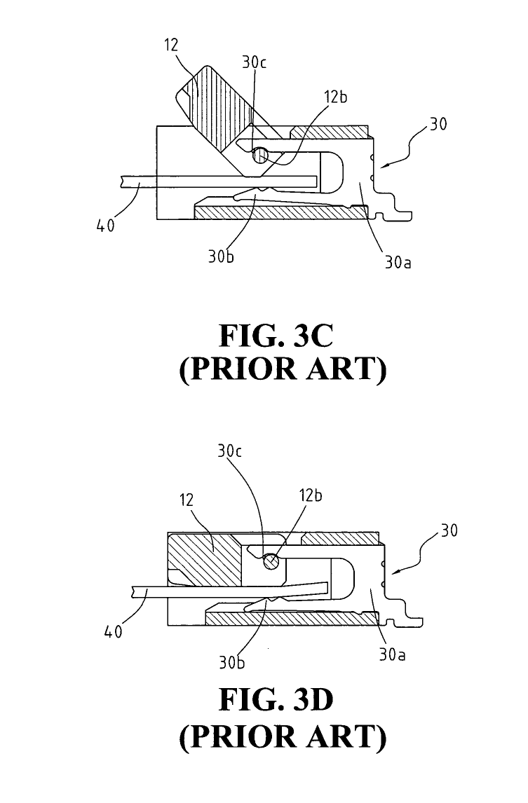

FIG. 3C shows that the axle is removed from the conventional terminal when the cover is pivoted to its close position;

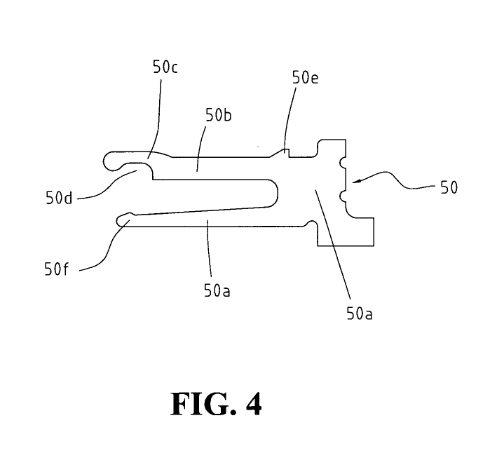

FIG. 3D shows that the axle is completely disengaged from the conventional terminal when the cover is closed;

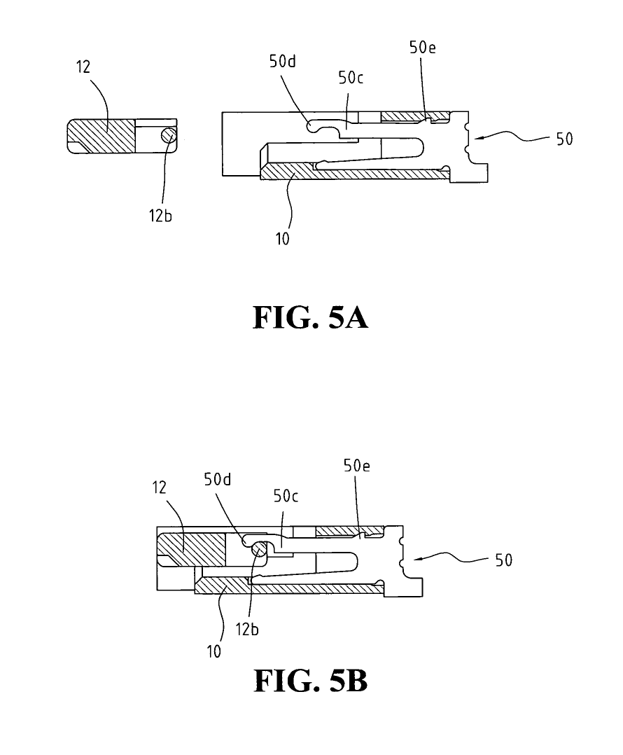

FIG. 4 shows the terminal of the present invention, and

FIGS. 5A to 5E show the five steps that that the terminal of the present invention is inserted into the connector, and the axle is engaged with the notches of the arms of the terminal of the present invention.

### DETAILED DESCRIPTION OF THE PREFERRED EMBODIMENT

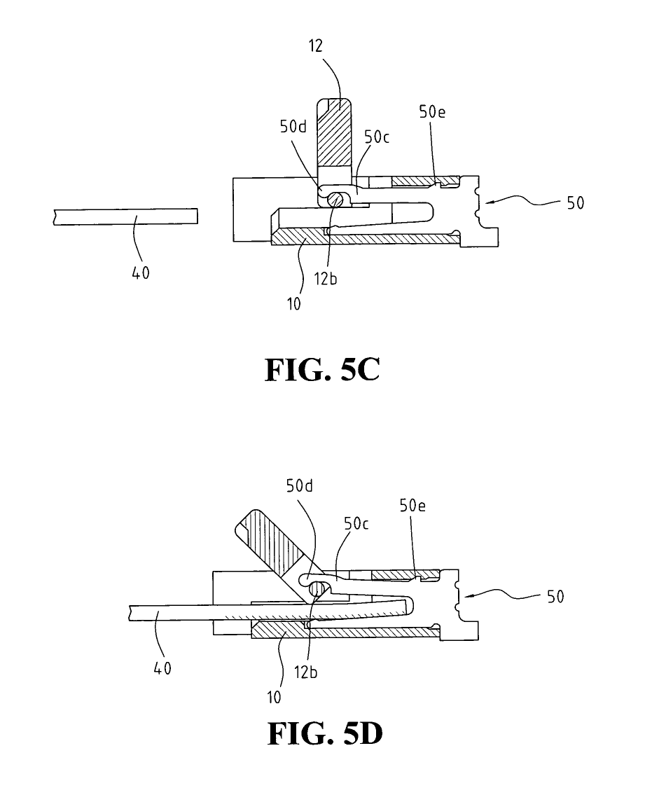

With reference to the drawings and in particular to FIG. 4, the terminal 50 of the present invention is a metal plate and has a base 50a from which a contact arm 50a and a connection arm 50b extend. The contact arm 50a has a terminal contact end 50f at a distal end thereof and the connection arm 50b has a connection portion 50c projecting from a distal end of a top thereof and a notch 50d is defined in the connection portion 50c. A sharp plate 50e extends from a top side of the connection arm 50b.

The connector 10 cooperated with the terminal 50 includes a passage defined in a rear end thereof and two engaging recesses are defined in two ends of the connector 10. A cover 12 has two positioning rods on two ends thereof and the positioning rods are engaged with the engaging recesses. A plurality of engaging teeth 12a are defined in an underside of the cover 12 and an axle 12b is located between the engaging teeth 12a. A space is defined between the passage and the engaging recesses of the connector 10.

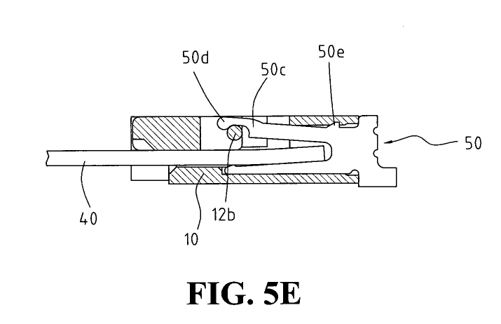

As shown in FIGS. 5A and 5B, when the terminal 50 extends through the passage of the connector 10, the connection portion 50c is pushed downward so that the terminal 50 can be easily inserted into the passage of the connector 10. The cover 12 is then pivotably connected to the connector 10 by engaging the positioning rods of the cover 12 with the engaging recesses of the connector 10. The connection arm 50b is pushed upward when contacting the axle 12b and the axle 12b is then engaged with the notch 50d as shown in FIG. 5B. The sharp plate 50e is in contact with an inside of the passage of the connector 10 so as to prevent the terminal 50 from being disengaged from the passage by the movement of the axle 12b of the cover 12.

As shown in FIGS. 5C to 5E, the cover 12 pivoted upward to its open position and a flatcable 40 is inserted into the space. The cover 12 is then pivoted downward to its close position and the flatcable 40 is clamped between the cover 12 and the contact arm 50a. The contact arm 50a has line contact ends which are in contact with the terminal contact end 50f of the terminal 50. During the pivotal actions of the cover 12, the connection arm 50b is positioned by the sharp plate 50e and the axle 12b is engaged with the notch 50d of the connection portion 50c so that the cover 12 is well positioned.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for connecting a terminal to a connector comprising the following steps:
providing a connector which includes a passage defined in a rear end thereof and two engaging recesses defined in two ends of the connector;
providing a cover having two positioning rods on two ends thereof, the positioning rods being engaged with the engaging recesses, a plurality of engaging teeth defined in an underside of the cover and an axle located between the engaging teeth;
providing a terminal which has a base from which a contact arm and a connection arm extend, the contact arm having a terminal contact end 50f at a distal end thereof, the connection arm having a connection portion projecting from a distal end thereof and a notch defined in the connection portion, a sharp plate extending from a top side of the connection arm;
the terminal extending through the passage of the connector and the connection portion being pushed downward so as to be inserted into the passage of the connector;
the cover being pivotably connected to the connector by engaging the positioning rods of the cover with the engaging recesses of the connector, the connection arm being pushed upward when contacting the axle and the axle being engaged with the notch, the sharp plate being in contact with an inside of the passage of the connector to prevent the terminal from being disengaged from the passage.

2. The method as claimed in claim 1, wherein a space is defined between the passage and the engaging recesses of the connector.

3. The method as claimed in claim 2 further comprising the following steps:
pivoting the cover to its open position and inserting a flatcable into the space, and
pivoting the cover to its close position and the flatcable having line contact ends which are in contact with the terminal contact end 50f of the terminal.

4. The method as claimed in claim 1, wherein the terminal is a metal plate.

5. A combination of a terminal and a connector wherein the connector includes a passage defined in a rear end thereof and two engaging recesses are defined in two ends of the connector;
a cover has two positioning rods on two ends thereof and the positioning rods are engaged with the engaging recesses, a plurality of engaging teeth are defined in an underside of the cover and an axle is located between the engaging teeth, and
the terminal has a base from which a contact arm and a connection arm extend, the contact arm has a terminal contact end at a distal end thereof, the connection arm has a connection portion projecting from a distal end thereof and a notch is defined in the connection portion, a sharp plate extends from a top side of the connection arm.

6. The combination as claimed in claim 5, wherein the terminal is a metal plate.

7. The combination as claimed in claim 5, wherein a space is defined between the passage and the engaging recesses of the connector, a flatcable is inserted into the space, the flatcable has line contact ends which are in contact with the terminal contact end of the terminal.
